(19) United States
(12) Patent Application Publication
(10) Pub. No.: US 2012/0036098 A1
(43) Pub. Date: Feb. 9, 2012

(54) ANALYZING ACTIVITIES OF A HOSTILE FORCE

(75) Inventors: Jeffrey E. Hanneman, Kirkland, WA (US); Brian Warn, Seattle, WA (US); Leonard J. Quadracci, Seattle, WA (US)

(73) Assignee: THE BOEING COMPANY, Chicago, IL (US)

(21) Appl. No.: 13/274,310

(22) Filed: Oct. 15, 2011

Related U.S. Application Data
(63) Continuation-in-part of application No. 11/763,353, filed on Jun. 14, 2007.

(51) Int. Cl. G06F 15/18

(52) U.S. Cl. 706/21

(57) ABSTRACT

Historical data is processed to identify possible future hostile activities in high threat environments. Pieces of the historical data are collected in computer-readable memory as memory entities, where the memory entities are categorized according to types of attacks and locations of attacks. The memory entities contain attributes taken from the pieces of historical data. A computer system is used to analyze the memory entities with an Associative Memory, wherein correlations of the attributes of the different memory entities are identified. Patterns are discovered from the correlations. The patterns are made available so future hostile activities can be identified.

This is a continuation-in-part of copending U.S. Ser. No. 11/763,353 filed 14 Jun. 2007.

### BACKGROUND

The Intelligence Community processes intelligence reports and other information in an attempt to predict hostile activities to land forces in high threat environments. Typically, intelligence analysts pore through intelligence reports to identify patterns that indicate hostile activities. The analysts rely upon personal experience, knowledge of the environment, and skill and talent to identify these patterns.

This task is daunting for a group of analysts, let alone a single analyst. There could be massive amounts of information to read. The sheer volume can be reduced by having others summarize the reports. However, the summaries might omit important information.

The ability to create mental associations between data varies between analysts. Some analysts will see patterns where others don't. Some analysts will retain more mental associations than others. Still, even an experienced analyst can't retain all mental associations.

Moreover, past experience is important. An experienced analyst might be able to identify unimportant information and discard it. An experienced analyst might be aware of key historical lessons and apply those lessons. Experience varies among analysts.

If a team of analysts is involved, communicating and coordinating information between the analysts can be difficult. The communication and coordination is especially difficult where hundreds or thousands of analysts are involved.

It would be desirable to improve the manner in which hostile threats are predicted. It would also be desirable to present hostile activity predictions to front line forces in a timely manner.

### SUMMARY

According to an embodiment herein, a method comprises processing historical data to identify possible future hostile activities in high threat environments. Pieces of the historical data are collected in computer-readable memory as memory entities, where the memory entities are categorized according to types of attacks and locations of attacks. The memory entities contain attributes taken from the pieces of historical data. A computer system is used to analyze the memory entities with an Associative Memory, wherein correlations of the attributes of the different memory entities are identified. Patterns are discovered from the correlations. The patterns are made available so future hostile activities can be identified.

According to another embodiment herein, a method comprises receiving intelligence reports about a geographic region, and storing the reports in computer-readable memory as memory entities. The memory entities are categorized according to types of attacks and locations of attacks, and they contain attributes taken from the reports. The method further comprises using a computer system to analyze the memory entities with an Associative Memory, whereby correlations in the attributes of the different memory entities are identified. Patterns from the correlations are discovered.

According to another embodiment herein, a system comprises a data collection module for receiving intelligence reports about a geographic region of interest, and storing the reports in computer-readable memory as memory entities. The memory entities are categorized according to types of attacks and locations of attacks. The memory entities contain attributes taken from the reports. The system further comprises an analysis module for analyzing the memory entities with an Associative Memory to identify correlations of the attributes of the different memory entities, and discover patterns from the correlations.

### BRIEF DESCRIPTION OF THE DRAWINGS

FIG. 1 is an illustration of a method of discovering patterns that identify possible future hostile activities.

FIGS. 2a and 2b are illustrations of examples of a memory entity.

FIG. 3 is an illustration of various formats of historical information.

FIGS. 4a and 4b are illustrations of examples in which a home station communicates with front line forces via network communications.

FIG. 5 is an illustration of a system for providing warnings to front line forces.

FIGS. 6a and 6b are illustrations of examples of alerts displayed by a client device.

FIG. 7 is an illustration of a client device for displaying hostile activities information.

### DETAILED DESCRIPTION

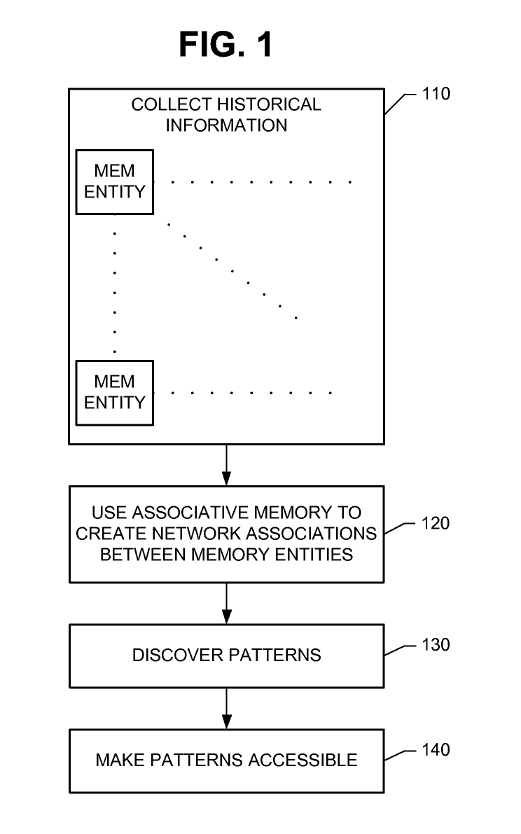

Reference is made to FIG. 1, which illustrates a method of identifying possible future hostile activities in high threat environments. The hostile activities may be characterized by type of attack. For instance, land forces conducting military operations might be concerned about small arms fire, improvised explosive devices (IED), Rocket Propelled Grenades (RPG) and other types of attacks. The land forces might be concerned about attacks occurring at locations such as plots of land, buildings, travel routes of convoys, landing zones, high traffic areas, etc. The land forces might be concerned about attacks occurring at certain times of day, during certain dates (e.g., anniversaries and holidays), and during certain weather patterns (e.g., dense fog).

At block 110, historical information is collected from disparate sources. The historical information may include intelligence reports, sensor data, and “lessons learned.” For instance, intelligence reports may contain buried weapons-employment patterns that show how insurgents are employing IED and RPG weapons and conducting suicide bombings and small-arms fire attacks against U.S. land forces. “Prepared” or “structured” intelligence reports may include or originate from, by way of example, observation reports, human intelligence (HUMINT), and electronic intelligence (ELINT). Unprepared or “unstructured” reports may include background briefings, e-mail intercepts, phone text, unedited video material, unedited intelligence reports or other unedited, unchanged or untreated activity.

Sensor data may include images, such as images obtained from satellite observations. Sensor data may also include acoustic signals, radar tracking, etc.

“Lessons learned” may include key historical lessons. “Lessons learned” may also include feedback (e.g., validation) on previous predictions.

At block 120, the pieces of historical information are ingested. The ingestion includes storing the pieces (e.g., reports) of the historical information as memory entities in computer-readable memory. Each memory entity is categorized according to a category of interest. For example, a memory entity may be categorized as a type of attack, a location, etc.

Each memory entity contains at least one attribute. An attribute may be a numeric value or text string, or it may be a range of values or a range of strings that are “like” a particular string. Examples of attributes for land force operations include, but are not limited to,
temporal information (e.g., time, date, holiday).
location information (e.g., latitude and longitude, weather, visibility).
occurrence of a hostile action (e.g., RPG attack).
occurrence of a non-hostile action (e.g., friendly armament, friendly transportation, presence of friendly tanks or other heavy equipment)
lessons learned.
type of source (satellite image, HUMINT).
any other information that was observed.

An attribute can have a specific value or a fuzzy value. A value can be numeric, text, Boolean, etc. Fuzzy values allow attributes to be represented to be consistent with a particular way in which Associative Memory understands and represents data.

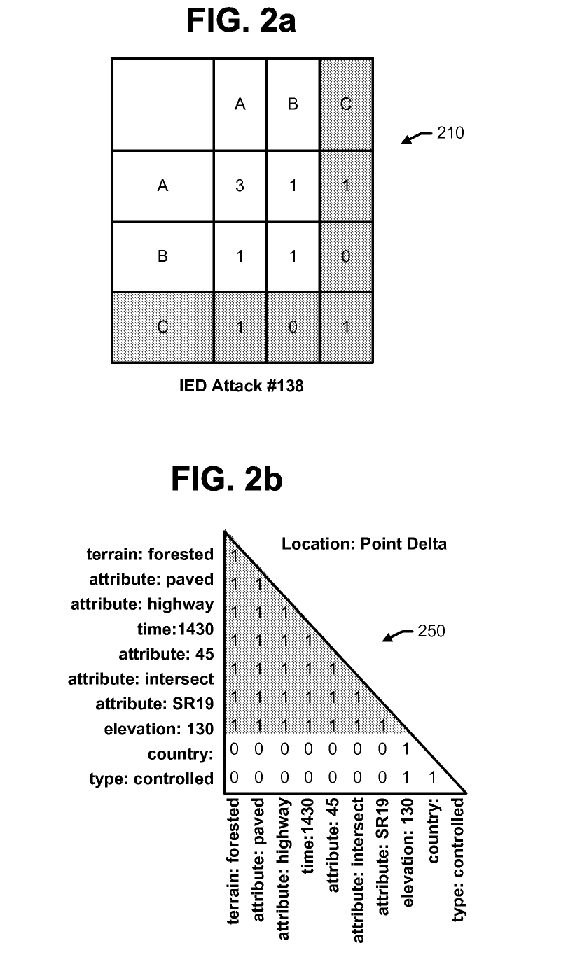

Additional reference is made to FIG. 2a, which illustrates an example a memory entity 210. The memory entity 210 is a matrix of attributes A, B and C. The matrix correlates the occurrence of each attribute A, B and C with an instance of the category (e.g., the 138^{th} instance of an IED attack). The matrix also correlates the different attributes with each other. Using the example of FIG. 2a, attribute A occurs 3 times in the different reports of the 138^{th} instance of an IED attack. In one of those reports mentioning attribute A, attribute B is also mentioned (but not attribute C). In another one of those reports mentioning attribute A, attribute C is also mentioned (but not also attribute B). None of those reports mention attributes B and C in the same report. Hence the frequency counts represented in FIG. 2a.

As new pieces of information are received, new attributes may be added to the memory entities and counts may be updated. In the example of FIG. 2a, attribute C is added to a matrix previously including only attributes A and B. The matrix is symmetrical.

FIG. 2b illustrates another example, this one containing details of attributes. FIG. 2b also illustrates a general property of the matrices: the matrices are symmetrical. Since a matrix is symmetrical, only half of it may be used.

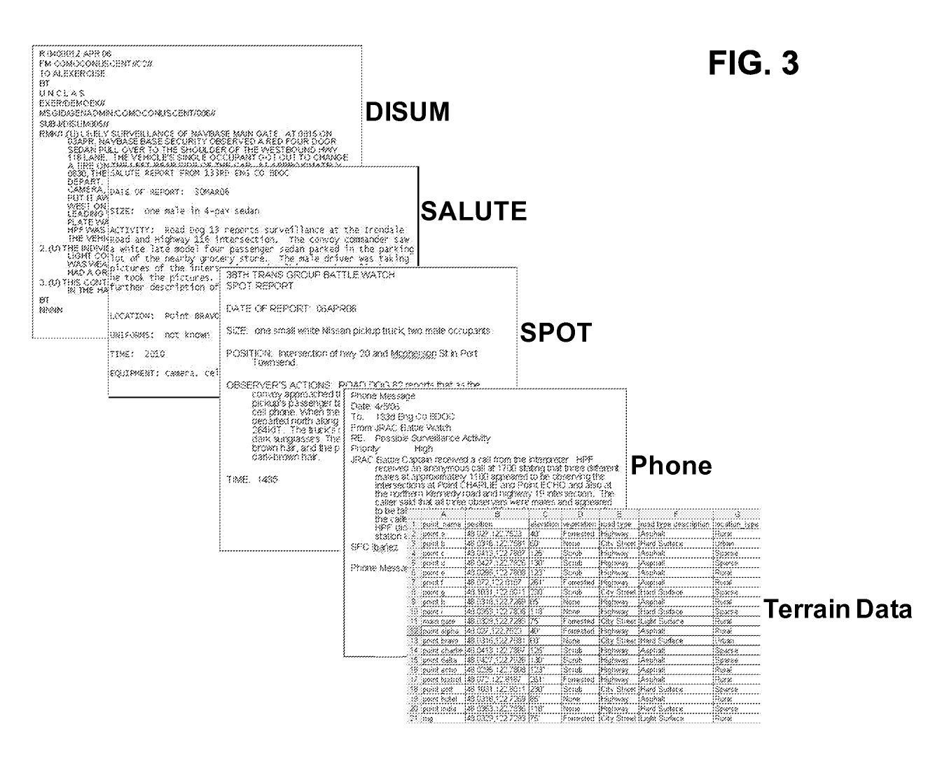

Additional reference is made to FIG. 3, which illustrates examples of pieces of information. The pieces illustrated in FIG. 3 include prepared intelligence reports following different formats (DISUM, SALUTE and SPOT). Each format specifies certain fields, which correspond to different attributes. The pieces illustrated in FIG. 3 also include phone calls and terrain data.

To obtain the attributes from a piece of information, the information piece may be parsed. The type of parsing will depend upon the format of a particular piece. As a first example, a regular expression parser may be used to parse information from structured or unstructured documents. Regular expression parsers identify structure of free text by applying rules to patterns of letters and numbers. For instance, the regular expression parser identifies a field and then follows a rule by extracting all text between the field and a period (.). In another instance, the regular expression parses any word having “AK-” followed by two digit, and extracts that word (e.g., AK-47) as a small armament.

As a second example, a semantic or ontology parser may be used to identify common terms in a piece of historical information. For instance, the semantic parser can recognize a name as a type of truck, and a numerical value as the number of occupants in the truck.

Consider the following example of two pieces of information. The first piece is an intelligence report about an IED attack. The report includes time, location, and casualties. From that piece, these various attributes are parsed and stored in a memory entity categorized as “IED attack.”

The second piece is an observation about a location. The observation includes latitude, longitude, elevation, vegetation, roads type, road description and location type. The observation also includes temperature and visibility weather at various times of day. The observation also mentions that an IED attack occurred at a given time. In a memory entity categorized by location, the IED attack will be an attribute of the location.

The second piece also identifies a bird observed at the location. This seemingly irrelevant attribute is included in the memory entity. No attempt is made to filter out it or any other attributes. To the contrary, seemingly irrelevant attributes might provide valuable information. For instance, that same bird might be spotted at multiple attack locations. That bird becomes an attribute of the attack. It is a prediction metric that an attack is more likely to occur when that attribute is present.

Reference is once again made to FIG. 1. Over time, large numbers of memory entities will be stored in computer memory.

At block 120, heteroassociative Associative Memory is used to analyze the number and quality of correlations between attributes of the different memory entities and identify the strength and correlation of attributes of similar entities. Heteroassociative memory can remember a completely different item to the one presented as input. (In contrast, autoassociative memory is capable of remembering data by observing a portion of that data.)

The Associative Memory (“AM”) may not understand the semantics of the values that it stores. Rather, it may understand them as symbols, and matches the symbols.

The predictive power of the AM comes from its potential ability to efficiently interpret and analyze the frequency of these co-occurrences and to produce various metrics in real-time. For more information on associative memory, see chapter 4 of Jeff Hawkins et al., “On Intelligence” Henry Holt and Company, ISBN-10: 0805074562.

At block 130, notional rules or patterns are identified from the connections and corresponding weights. For example, 1000 memory entities are categorized as IED attack. Of those matrices, 70% have strong connections between attributes A, B, and C but not attributes D, E, and F. Therefore, the pattern for IED attack could be based on the simultaneous presence of attributes A, B and C. In this manner, recurring patterns, anomalies and opportunities for improving operational planning are identified.

Different types of attacks can be distinguished by differences in the inputs. For instance, an IED attack and a small arms fire attack might share the same group of attributes. However, the IED has several additional attributes. Inputs corresponding to those additional attributes would distinguish an IED attack from a small arms fire attack.

The method of FIG. 1 can process an abundance of historical information about hostile activities, and use Associative Memory to identify patterns in the historical information. Those patterns can then be used to predict future activities or, at least, to provide warnings about possible future activities.

The use of Associative Memory can discover new patterns that might not be apparent to an experienced analyst or even a team of analysts. It can establish patterns between attributes that are disjoint or counter-intuitive.

In some instances, patterns may be identified in vast amounts of data about hostile activities that occur within a given area of operations, more data than can be processed by an analyst. In other instances, hidden patterns can be revealed even though the historical data is sparse.

A method herein can take advantage of key historical lessons. The historical lessons can be used in various ways. As a first example, they are used to define an initial matrix. Based on past observations, certain attributes are known to occur during an event. An initial matrix can then be created with these known attributes. As additional historical information is gathered, attributes may be added to the initial matrix. In this manner, the historical lessons are used as seeds.

As a second example, historical information is added as attributes to memory entities. For instance, a person on a ridge in the middle of the day is observed. That observation is added to the matrices as an attribute.

Faster processing and pattern recognition times can be achieved by computers than individual analysts or even a team of analysts. Consequently, trend information can be presented quickly to front line forces.

The patterns are updated as new information is collected. The new information might come in the form of new sensor data, which allows new memory entities to be stored in computer memory. Additional associations are created, and new patterns are generated. The new information might come in the form of lessons learned. Historical data can be used to validate existing patterns.

At block 140, the patterns are made accessible to other parties so that possible future activities by hostile forces are identified. This may be done in a variety of ways. As a first example, computers are preloaded with patterns and given to front line forces. During operation, each computer obtains current data, applies the patterns to that current data, and issues alerts.

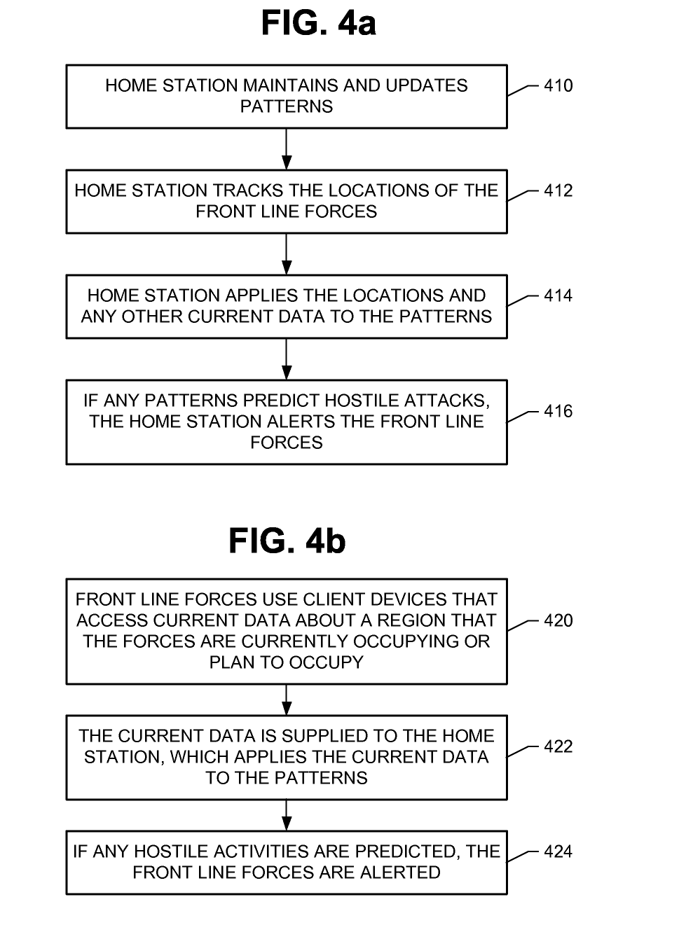

FIGS. 4a and 4b provide some other examples in which a remote home station communicates with front line forces via network communications. The home station may be a facility that is run by the Intelligence Community.

FIG. 4a provides an example in which alerts are pushed onto front line forces. The home station maintains and updates patterns (block 410), continually tracks the locations of the front line forces (block 412), and applies the locations and any other current data to the patterns (block 414). In some instances, the home station can ping client devices of front line forces to determine their whereabouts, and send out warnings based on those whereabouts. If any patterns predict hostile attacks, the front line forces are alerted (block 416). For instance, the patterns might predict where an IED is placed or where an ambush is planned. The severity of the alert (e.g., red alert, yellow alert) is based, for example, on the number of attributes that are matched, the strength of the correlations and the sparseness of the information.

FIG. 4b provides an example in which alerts are pulled from the home station. Front line forces use client devices that access current data about a region that the forces are currently occupying or plan to occupy (block 420). The current data is supplied to the home station, which applies the current data to the patterns (block 422). If any hostile activities are predicted, the front line forces are alerted (block 424). For instance, a convoy plans to follow a route to a destination. Based on the patterns and current location of convoy and other current data, the convoy is alerted to the possibility of hostile activities along the route. Changes to aspects of the operation may be made, for example, by increasing number of heavy equipment units in a convoy, avoiding a particular place at a particular time, or changing routes, armament, transport equipment or other operational parameters.

The patterns may be used in other ways. For instance, the patterns may be used to train analysts, for example, by teaching relationships among attributes and identifying activity segments “like this” (i.e., similar to an extant activity of a hostile force) for treatment in a particular way.

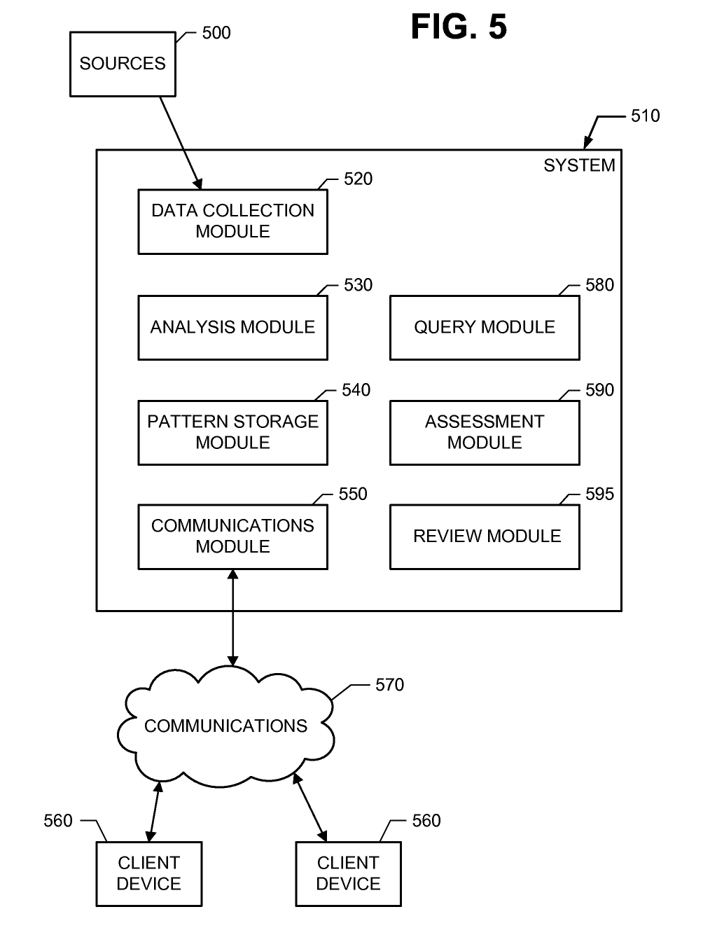

Reference is now made to FIG. 5, which illustrates a system 510 for providing hostile activities information to front line forces. The hostile activities information can include any one or more of patterns, predictions, alerts, recommendations, trends, mitigation plans, social networks of people, etc.

The system 510 includes hardware and software. The hardware may range from a single laptop computer to a server system to cluster of distributed computers. The software is executed by the hardware. The system will now be described as a plurality of modules. Each module may include a combination of hardware and software.

A data collection module 520 communicates with various sources 500 to collect intelligence reports and other information about a geographic region of interest. The data collection module 520 stores the reports in computer-readable memory as memory entities.

An analysis module 530 analyzes the memory entities with an Associative Memory to make weighted connections between the attributes of the different memory entities. Commercial Off-the-Shelf (COTS) AM software is available from Saffron Technology of Morrisville, N.C. For instance, SAFFRON ENTERPRISEOne™ may be configured to identify correlations between attributes of the memory entities and discover patterns from the strength and number of the correlations

The system 510 further includes a means for making the patterns and other hostile activities information available to front line forces so the forces can identify hostile activities. In the system 510 of FIG. 5, such means includes a pattern storage module 540, and a communications module 550. The pattern storage module 540 stores the patterns identified by the analysis module 530. The number of stored patterns will depend upon the challenge at hand. In some instances, there might be a couple of patterns for each type of attack, In other instances, there might be many patterns for each type of attack.

The communications module 550 communicates with client devices 560 of front line forces via a communications network 570. Examples of a communications network 570 include, but are not limited to, Single Mobility System (SMS), and single channel radio such as PRC-117. When linked with GPS, the GPS can identify the location of a client device 560, and the system 510 can look at patterns for that location.

The system 510 of FIG. 5 also includes a query module 580, which allows the system 510 to evaluate patterns. For instance, a client device 560 contacts the system 510, identifies its location, and sends a request for information about possible hostile activities with respect to its location. The query module 580 generates a query and sends the query to an assessment module 590. The query may include the location of the client device, and any other current data that is available.

The assessment module 590 receives the queries and evaluates one or more patterns based on the location of the client device 560 and other current data. An indication may be provided to a user review module 595.

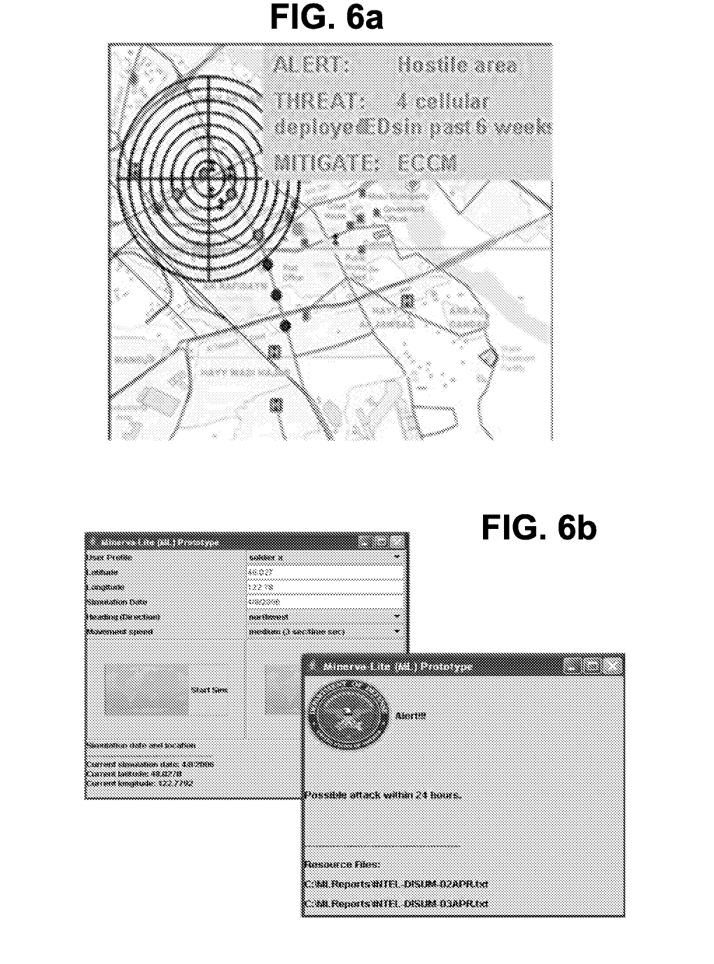

The user review module 595 enables the hostile activities information to be reviewed. Based on the review, alerts are issued to front line forces. FIGS. 6a and 6b illustrate some examples of alerts.

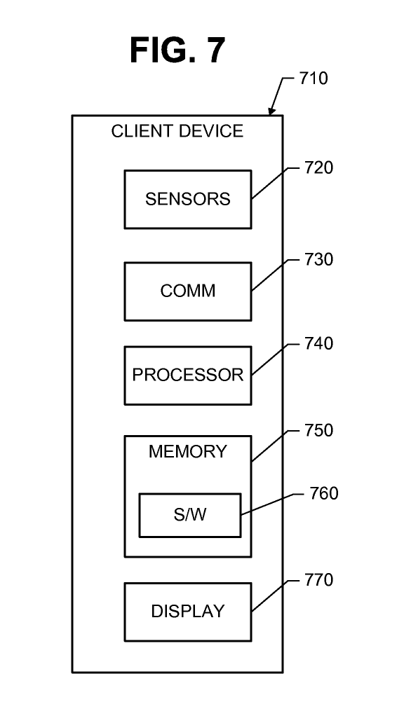

Reference is now made to FIG. 7, which illustrates an example of a client device 710. The client device 710 of FIG. 7 includes sensors 720, and communications 730 for communicating with a home station. The client device 710 further includes a processor 740 and memory 750 for storing software 760.

Depending on the “intelligence” of the client device 710, the client device 710 could simply send requests to the system 510 of FIG. 5 and display hostility activities information returned by the system 510. A more intelligent device 710 could retrieve patterns from the system 510 and generate its own queries and perform its own assessment based on location and other current information.

The client device 710 further includes a graphics user interface (part of the software 760) and a display 770 for displaying hostile activities information such as alerts, suggestions to avoid attacks (e.g., alter a plan of operation as critical situations are developing in order to preventively influence the course of events), etc.

1. A method comprising processing historical data to identify possible future hostile activities in high threat environments, including
collecting the historical data in computer-readable memory as memory entities, the memory entities categorized according to types of attacks and locations of attacks, the memory entities containing attributes taken from the pieces of historical data;
using a computer system to analyze the memory entities with an Associative Memory, wherein correlations of the attributes of the different memory entities are identified;
discovering patterns from the correlations; and
making the patterns available so future hostile activities can be identified.

2. The method of claim 1, wherein the memory entities include matrices of attributes, wherein each matrix correlates the occurrence of each attribute with an instance of the category, and also correlates different attributes within the instance.

3. The method of claim 2, further comprising adding lessons learned as attributes of the matrices.

4. The method of claim 1, wherein collecting the historical data includes parsing intelligence reports and storing parsed terms as the attributes.

5. The method of claim 1, wherein the associative memory is heteroassociative memory.

6. The method of claim 1, wherein the associative memory analyzes number and quality of correlations between the attributes of the memory entities and identifies the strength and correlation of the attributes of similar entities.

7. The method of claim 1, further comprising making the patterns accessible to allow third parties to identify future activities by hostile forces.

8. The method of claim 1, further comprising applying the patterns to current data to identify future activities.

9. The method of claim 1, wherein the future hostile activities include weapon attacks.

10. The method of claim 1, wherein the patterns are determined for different geographic locations.

11. A method comprising
receiving intelligence reports about a geographic region;
storing the reports in computer-readable memory as memory entities, the memory entities categorized according to types of attacks and locations of attacks, the memory entities containing attributes taken from the reports;
using a computer system to analyze the memory entities with an Associative Memory, whereby correlations in the attributes of the different memory entities are identified; and
discovering patterns from the correlations.

12. A system comprising:
a data collection module for receiving intelligence reports about a geographic region of interest, and storing the reports in computer-readable memory as memory entities, the memory entities categorized according to types of attacks and locations of attacks, the memory entities containing attributes taken from the reports; and
an analysis module for analyzing the memory entities with an Associative Memory to identify correlations of the attributes of the different memory entities, and discover patterns from the correlations.

13. The system of claim 12, wherein the future hostile activities include weapon attacks.

14. The system of claim 12, further comprising client devices for accessing hostile activities information from the means.

15. The system of claim 12, wherein the Associative Memory is heteroassociative memory.

16. The system of claim 12, wherein the associative memory analyzes number and quality of correlations between the attributes of the memory entities and identifies the strength and correlation of the attributes of similar entities.

17. The system of claim 12, wherein the data collection module parses structured and unstructured reports to obtain the attributes.

18. The system of claim 12, further comprising means for applying the patterns to current data to identify future activities.

19. The system of claim 12, further comprising means for making the patterns accessible to allow third parties to identify future activities by hostile forces

20. The system of claim 12, wherein the memory entities include matrices of attributes, wherein each matrix correlates the occurrence of each attribute with an instance of the category, and also correlates different attributes within the instance.
